(19) United States
(12) Patent Application Publication
(10) Pub. No.: US 2025/0296033 A1
(43) Pub. Date: Sep. 25, 2025

(54) ACID GAS REMOVAL METHOD AND ACID GAS REMOVAL SYSTEM

(71) Applicants: Kabushiki Kaisha Toshiba, Tokyo (JP); Toshiba Energy Systems & Solutions Corporation, Kawasaki-shi (JP)

(72) Inventors: Akiko SUZUKI, Ota (JP); Yoshihiko NAKANO, Yokohama (JP); Reiko YOSHIMURA, Kawasaki (JP); Hitomi SAITO, Taito (JP); Asato KONDO, Yokohama (JP); Shinji MURAI, Sagamihara (JP); Noriko TAKADA, Meguro (JP)

(73) Assignees: Kabushiki Kaisha Toshiba, Tokyo (JP); Toshiba Energy Systems & Solutions Corporation, Kawasaki-shi (JP)

(21) Appl. No.: 19/065,565

(22) Filed: Feb. 27, 2025

(30) Foreign Application Priority Data
Mar. 19, 2024 (JP) 2024-043816

(51) Int. Cl. B01D 53/14; B01D 53/18; B01D 53/62; B01D 53/78; B01D 53/96; C01B 32/50; C02F 1/44

(52) U.S. Cl. CPC B01D 53/1425; B01D 53/1418; B01D 53/1475; B01D 53/1493; B01D 53/18; B01D 53/62; B01D 53/78; B01D 53/96; C01B 32/50; C02F 1/44; B01D 2252/103; B01D 2252/20426; B01D 2257/504; B01D 2258/0283

(57) ABSTRACT

According to one embodiment, an acidic gas removal method for removing an acidic gas from a gas to be treated containing the acidic gas, the method includes, bringing the gas to be treated into contact with an acidic gas absorbent to cause the acidic gas absorbent to absorb the acidic gas as a first step; and obtaining a draw solution diluted with water by using the acidic gas absorbent having absorbed the acidic gas as a draw solution and allowing water contained in the water to be treated to permeate through a semipermeable membrane to the draw solution side as a second step.

### CROSS-REFERENCE TO RELATED APPLICATION(S)

This application is based upon and claims the benefit of priority from Japanese Patent Application No. 2024-043816, filed Mar. 19, 2024, the entire contents of which are incorporated herein by reference.

### FIELD

Embodiments of the present invention relate to an acid gas removal method, and an acid gas removal system.

### BACKGROUND

In recent years, a greenhouse effect caused by an increase in carbon dioxide (CO2) concentration has been pointed out as one factor for global warming phenomena, and international measures for protecting the environment on a global scale are urgently needed. CO2 is generated mainly by industrial activities, and there is a growing momentum to suppress emission of CO2 to the environment. In particular, reduction in CO2 emissions from coal-fired power plants and factories is urgently needed. In addition to CO2, it has also been attempted to reduce emissions of acid gases such as hydrogen sulfide (H2S).

Therefore, as methods for reducing emissions of acid gases such as CO2, reduction in emissions by increasing the efficiency of thermal power plants and the like, and recovery of carbon dioxide by a chemical absorbent have attracted great attention. As a specific absorbent, absorption by an amine compound has been studied for a long time. However, in steps of absorbing and releasing CO2 by the chemical absorbent, it is known that the absorbent is sometimes heated in order to regenerate the chemical absorbent, whereby the amine compound contained in the absorbent is oxidized and deteriorated. In addition, it is known that an exhaust gas contains not only carbon dioxide but also SOx, NOx, and the like, and also that these compounds also accelerate deterioration in amine compound and form a thermally stable salt with an amine compound (Patent Document 1). The oxidization of and deterioration in an amine compound or the formation of a thermally stable salt results in a decrease in acid gas absorption performance. Therefore, it is necessary to maintain the acid gas absorption performance by a regeneration treatment by distillation or electrodialysis of the amine compound or complete replacement of an absorption liquid. When the absorption liquid is completely replaced, a large amount of waste of the amine compound is produced, and thus it is also necessary to devise to reduce a load on the environment.

### DESCRIPTION OF THE DRAWINGS

FIG. 1 is a schematic diagram of an acid gas removal system according to an embodiment.

FIG. 2 is a view showing a water treatment apparatus of a second modification of the first embodiment.

### DETAILED DESCRIPTION

In general, according to one embodiment, an acidic gas removal method for removing an acidic gas from a gas to be treated containing the acidic gas, the method includes
bringing the gas to be treated into contact with an acidic gas absorbent to cause the acidic gas absorbent to absorb the acidic gas as a first step; and
obtaining a draw solution diluted with water by using the acidic gas absorbent having absorbed the acidic gas in the first step as a draw solution and allowing water contained in the water to be treated to permeate through a semipermeable membrane to the draw solution side as a second step.

In general, according to another embodiment, a acidic gas removal system includes an absorption apparatus including an absorber capable of accommodating an acidic gas absorption liquid capable of absorbing acidic gas, and
a water treatment apparatus including a treatment vessel including a first chamber capable of containing water to be treated, a second chamber provided on a downstream side of the absorber and capable of containing a draw solution, and a semipermeable membrane that separates the first chamber and the second chamber from each other.

Hereinafter, a first embodiment will be described with reference to the drawings. The first embodiment does not limit the present invention. The same parts in the drawings are denoted by the same reference numerals, and detailed description thereof will be omitted as appropriate, and different parts will be described. The drawings are schematic or conceptual, and the relationship between the thickness and width of each portion, the size ratio between portions, and the like are not necessarily the same as the actual ones. Further, even when the same portion is illustrated, the dimensions and the ratios may be illustrated differently depending on the drawings.

Unless otherwise specified, values obtained by pH or other measurements are values measured at atmospheric pressure and 25° C.

### First Embodiment

### <Acidic Gas Removal System>

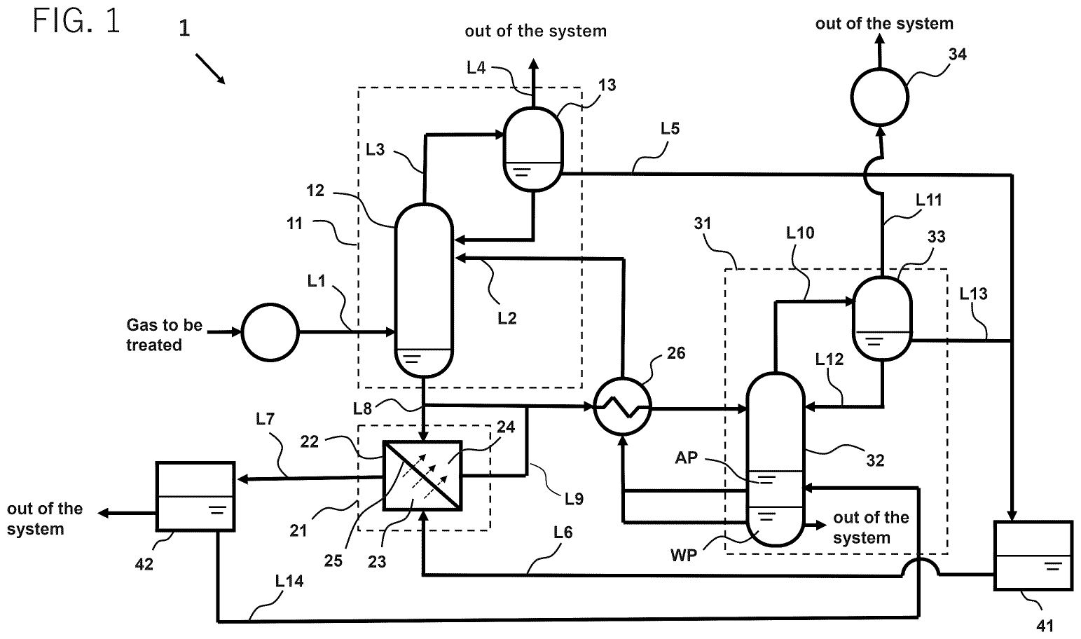

FIG. 1 is a schematic diagram of an acid gas removal system according to a first embodiment.

The acidic gas removal system 1 according to the first embodiment includes an absorption apparatus 11 and a water treatment apparatus 21.

The absorption apparatus 11 includes an absorber 12 that brings a gas to be treated containing an acidic gas into contact with an acidic gas absorbent, causes the acidic gas absorbent to absorb the acidic gas to remove the acidic gas from the gas to be treated, and obtains the acidic gas absorbent (first solution) having absorbed the acidic gas.

The water treatment apparatus 21 includes a treatment vessel 22. The treatment vessel 22 includes a first chamber 23 and a second chamber 24 disposed in the treatment vessel 22, and a semipermeable membrane 25 that separates the first chamber 23 and the second chamber 24.

As shown in FIG. 1, a carbon dioxide containing exhaust gas (gas to be treated) such as a combustion exhaust gas emitted from a thermal power plant or the like is guided to a lower portion of the absorber 12 through the gas inlet L1. The exhaust gas is pushed into the absorber 12 and comes into contact with the acidic gas absorbent supplied from the acidic gas absorbent supplying port L2 at the upper portion of the absorber 12. As the acidic gas absorbent, an acidic gas absorbent according to a first embodiment described below can be used.

Since the acidic gas absorption liquid is separated into two phases in a stationary state, it is preferable that the acidic gas absorption liquid is brought into a dispersed state by stirring or the like prior to the contact. The acidic gas absorbent may contain, in addition to the specific amine compound and water, other compounds such as a nitrogen-containing compound for improving the absorption performance of carbon dioxide, an antioxidant, and a pH adjuster in an arbitrary ratio.

In this way, when the exhaust gas comes into contact with the acidic gas absorbent, the amine compound in the acidic gas absorption liquid reacts with carbon dioxide in the exhaust gas to form a salt, and the acidic gas absorbent is changed from a two phase state to a homogeneous state. On the other hand, carbon dioxide in the exhaust gas is absorbed and removed by the acidic gas absorbent. The exhaust gas from which carbon dioxide has been removed (the treated gas after the treatment) is discharged from the gas outlet L3 to the outside of the absorber 12.

The top of the absorber 12 is connected to the diffusion suppressing unit 13 through a gas outlet port L3. The treated gas after the treatment accompanied by the absorption liquid in the absorber 12 is sent to a diffusion suppressing port 13 provided on the downstream side of the absorber 12 through a gas outlet port L3. In the diffusion suppression unit 13, the absorption liquid component (amine) accompanying the gas to be treated after the treatment is scrubbed with washing water in order to avoid diffusion into the environment. Therefore, the amine-containing washing water (water to be treated described later) is temporarily stored in the diffusion suppression unit 13. The treated gas in the diffusion suppressing part 13 is discharged from the flow path L4 to the outside of the system.

The diffusion suppressing portion 13 is connected to the water to be treated tank 41 by a flow path L5. The amine-containing washing water (water to be treated) in the diffusion suppressing portion 13 is sent to the water to be treated tank 41 provided on the downstream side of the diffusion suppressing portion 13 through the flow path L5. The treatment of the washing water (water to be treated) stored in the water to be treated tank 41 will be described later.

### <Method for Removing Acidic Gas>

In the method for removing an acidic gas according to the first embodiment, a gas to be treated containing an acidic gas is brought into contact with an acidic gas absorbent to remove the acidic gas from the gas to be treated.

The method for removing an acidic gas according to the first embodiment basically includes a step (first step: absorption step) of causing an acidic gas absorbent to absorb an acidic gas to obtain an acidic gas absorbent having absorbed the acidic gas (first solution), and a step (second step) of allowing water to permeate from water to be treated through a semipermeable membrane using the acidic gas absorbent having absorbed the acidic gas (first solution) as a draw solution.

In the first step (absorption step), the method for bringing the gas to be treated containing the acidic gas into contact with the acidic gas absorbent is not particularly limited, and examples thereof include a method of bubbling the gas to be treated in the acidic gas absorbent, a method of spraying the acidic gas absorbent into the gas stream of the gas to be treated, a method of bringing the gas to be treated and the acidic gas absorbent into countercurrent contact in an absorber containing a magnetic or metal mesh filler, and a method of introducing the acidic gas and the acidic gas absorbent together into a static mixer. In any of the methods, the acidic gas absorbent which has not absorbed the acidic gas tends to separate into two phases, and therefore, the acidic gas absorbent is preferably stirred before or during the contact.

The temperature of the first step (absorption step) is usually preferably from room temperature to 60° C. The temperature is more preferably 50° C. or lower, and particularly preferably from 20° C. to 45° C. In general, the amount of the acidic gas absorbed increases as the temperature decreases, but the lower limit of the treatment temperature can be determined by the gas temperature in the process, the heat recovery target, and the like. The pressure during the acid gas absorption is usually about atmospheric pressure. Although the pressure can be increased to a higher pressure in order to enhance the absorption performance, the compression is preferably performed under atmospheric pressure in order to suppress the energy consumption required for the compression.

### <Acidic Gas Absorbent>

In the following embodiments, a case where the acidic gas is carbon dioxide will be mainly described as an example, but the acidic gas absorbent according to the first embodiment can obtain the same effect with respect to other acidic gases such as hydrogen sulfide. The acidic gas absorbent according to the embodiment is suitable for absorbing an oxidized gas such as carbon dioxide or hydrogen sulfide. Among these, the present embodiment is particularly suitable for absorption of carbon dioxide, and is suitable for removal and recovery of carbon dioxide from a gas to be treated such as a factory exhaust gas.

The acidic gas absorbent according to the first embodiment has a function of absorbing the acidic gas exemplified above. The acidic gas absorbent preferably includes a polarity inversion compound. The polarity inversion compound will be described later. The acidic gas absorbent contains, for example, an amine compound and water as a main agent that absorbs acidic gas. The amine compound used here is a liquid amine compound having a secondary amine structure, and is an acidic gas removing agent containing a mixture of the liquid amine compound and water, in which the amount of a salt formed from the liquid amine compound and an acidic gas dissolved in water is higher than the amount of the liquid amine compound itself dissolved in water. Here, the liquid amine compound is an amine compound which is liquid at 25° C. under atmospheric pressure. The liquid amine compound generally has a low solubility at room temperature, for example, a solubility of 50000 mg/L or less at 25° C. When the liquid amine compound comes into contact with an acidic gas, a salt is formed, and when water is present, the liquid amine compound is ionized and the amount of dissolution increases. The amount of such a salt dissolved at 25° C. is, for example, 2 times or more, preferably 5 times or more, and more preferably 10 times or more the amount of the liquid amine dissolved as a base. In the first embodiment, the amount of dissolution (mg/L) is the mass (mg) of the liquid amine based on the total volume (L) of water and the liquid amine compound.

The liquid amine compound contained in the acidic gas absorbent according to the first embodiment is dissolved in water in an increased amount when coming into contact with an acidic gas, but is not compatible with water before coming into contact with an acidic gas. Thus, the liquid amine compound is in a state where an organic phase (a phase containing the liquid amine compound) and an aqueous phase are separated, typically in a two phase state. When the acidic gas absorbent comes into contact with the acidic gas, the liquid amine compound is charged and easily dissolved in water, and thus the two phases are compatible with each other, and the acidic gas absorbent typically becomes a single phase. The acidic gas absorbent after absorbing the acidic gas can release the acidic gas by heating or pressure reduction, and has a property of forming two phases of the liquid amine compound and water again after the release. A material having such a property is called a polarity inversion compound.

Therefore, the acidic gas absorbent according to the first embodiment can be regenerated by a treatment such as heating or pressure reduction. Even in the case of a general acidic gas absorbent, regeneration may be performed by heating or the like, but in such a case, the heating temperature needs to be 120° C. or higher. In contrast, in the acidic gas absorbent according to the first embodiment, when the acidic gas absorbent is regenerated by heating, the acidic gas absorbent can be regenerated at a heating temperature of, for example, 80° C. or lower, and preferably 70° C. or lower.

The acidic gas absorbent is generally used repeatedly for removal and recovery of acidic gas from gas to be treated, but the use thereof gradually progresses deterioration due to impurities such as water-soluble amine degradation products, metal ions, thermally stable salts, and organic acids. In a case where the acidic gas absorbent according to the first embodiment is contaminated with impurities, when the acidic gas is released from the acidic gas absorbent and separated into an amine compound phase and an aqueous phase, the contaminants are dissolved in the aqueous phase, and thus the liquid amine compound and the contaminants can be separated. The acidic gas absorbent can be regenerated by adding water to the liquid amine compound after separation. In addition, if the separation of the liquid amine compound and the contaminants can be appropriately performed, and further, if the concentration of the contaminants can be appropriately performed, the discharge amount of the contaminants can be reduced in addition to the regeneration of the acidic gas absorbent, and thus, the reduction of the environmental load and the making the system more compact can be achieved.

Here, in the first embodiment, the “state in which the organic phase and the aqueous phase are phase-separated” means, for example, a state in which the mixture of water and the liquid amine is phase-separated into the organic phase and the aqueous phase, in other words, a state in which the boundary between the organic phase and the aqueous phase can be visually confirmed. Here, in the present embodiment, the organic phase is a phase containing the liquid amine compound as a main component in a phase-separated state, and is a phase containing the liquid amine compound at a high concentration in a state of being separated from the acidic gas. The aqueous phase is a phase containing water as a main component in a phase-separated state. In the acidic gas absorbent, when the carbon dioxide concentration is high, the amount of the liquid amine compound dissolved in water increases, and the liquid amine compound is dissolved in the aqueous solution. In this state, the acidic gas absorbent is not phase-separated into an organic phase and an aqueous phase (the acidic gas absorbent is in a single phase). When the acidic gas concentration of the acidic gas absorbent is low, the solubility of the liquid amine compound in water decreases, and the acidic gas absorbent is phase-separated into an aqueous phase and an organic phase containing the liquid amine compound at a high concentration. In the case of phase separation, typically, an organic phase and an aqueous phase form two complete phases. However, in the present embodiment, even in the case where the phase separation is not complete, the phase separation is referred to as “two phases” when the phase boundary can be confirmed.

The liquid amine compound used in the embodiment has a secondary amine structure, and as described above, the amount of the liquid amine compound dissolved in water changes by contact with an acidic gas.

When the liquid amine compound used in the present embodiment has a structure of a secondary amine and a tertiary amine, the secondary amine structure preferably exists more than the tertiary amine structure. The liquid amine compound of the present embodiment preferably contains one or more secondary amine structures and one or less tertiary amine structures.

Such liquid amine compounds are preferably represented by the following formula (a) or (b).

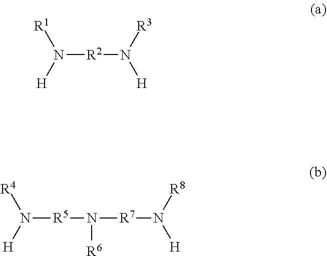

### Wherein

R¹, R³, R⁴, and R⁸ are each independently linear alkyl groups, branched alkyl groups, cyclic alkyl groups, heterocyclic aliphatic groups containing oxygen or sulfur, substituted or unsubstituted aliphatic groups consisting of three elements of C, N and H, or substituted or unsubstituted aromatic groups,
R², R⁵, and R⁷ are each independently a C1 to C7 linear alkylene chains or C3 to C7 branched alkylene chains, and
R⁶ is linear alkyl groups, branched alkyl groups, substituted or unsubstituted aliphatic groups composed of three elements of carbon, nitrogen and hydrogen atoms, a substituted or unsubstituted aromatic group, or hydrogen.

Here, more preferably,
R¹, R³, R⁴, and R⁸ are each independently a linear or branched C3 to C6 alkyl group,
R², R⁵, and R⁷ are each independently a C2 to C4 linear alkylene chain or a C3 to C4 branched alkylene chain, and
R⁶ is hydrogen or a linear or branched C1 to C3 alkyl group.
R¹ and R³ are more preferably the same. Also, R4 and R8 are more preferably the same.
R⁵ and R⁷ are more preferably the same.

The liquid amine compound represented by the formula (a) more preferably has a structure symmetrical with respect to the R². The liquid amine compound represented by the formula (b) more preferably has a structure symmetrical with respect to the NR6.

From the viewpoint of responsiveness of phase separation in response to carbon dioxide, the number of carbon atoms relative to the number of nitrogen atoms (C/N) contained in the liquid amine compound represented by Formula (a) and/or Formula (b) is preferably 4 or more and 12 or less, more preferably 4 or more and 10 or less, and even more preferably 5 or more and 8 or less. A small number of carbon atoms relative to the number of nitrogen atoms tends to result in easy dissolution of the liquid amine compound in water and difficulty in phase separation, and thus caution is required. In addition, a large number of carbon atoms relative to the number of nitrogen atoms may result in a high viscosity and difficulty in handling, and thus caution is required. From the above viewpoints, the number of carbon atoms relative to the number of nitrogen atoms (C/N) contained in the secondary amine compound represented by Formula (a) is more preferably 5 or more and 7 or less, and even more preferably more than 5 and 7 or less.

R6 is more preferably a methyl group or hydrogen.

R2 is more preferably a linear propylene chain. Also, R6 is more preferably a linear propylene chain. Also, R7 is more preferably a linear propylene chain.

Specific examples of such a liquid amine compound include the following compounds.
Et₂CH—NH(CH₂)₂NH—CHEt₂
Et₂CH—NH(CH₂)₃NH—CHEt₂
Et₂CH—NH(CH₂)₄NH—CHEt₂
Et₂CH—NH(CH₂)₅NH—CHEt₂
Et₂CH—NH(CH₂)₆NH—CHEt₂
Cyclopentyl-NH(CH₂)₂NH-Cyclopentyl
Cyclopentyl-NH(CH₂)₃NH-Cyclopentyl
Cyclohexyl-NH(CH₂)₃NH-Cyclohexyl
Me₃C—NH(CH₂)₃NH—CMe₃
Me₂CHCH₂MeCH—NH(CH₂)₃NH—CHMeCH₂CHMe₂
Me₂CHCH₂MeCH—NH(CH₂)₄NH—CHMeCH₂CHMe₂
Me₂CHCH₂MeCH—NH(CH₂)₂NH—CHMeCH₂CHMe₂
EtMeCH—NH(CH₂)₂NH—CHMeCH₂CHMe
Cyclopentyl-NH(CH₂)₂NH—CHEt₂
Cyclohexyl-NH(CH₂)₃NH—CHEtMe
EtMeCH—NH(CH₂)₂NH—CHMeCH₂CHMe₂
(Me₂CH)₂CH—NH(CH₂)₂NH—CHMe₂
EtMeCH—NH(CH₂)₂NH—CH(CHMe₂)₂
Me₂CHCH₂MeCH—NH(CH₂)₂NH(CH₂)₂NH—CHMeCH₂CHMe₂
Me₂CHCH₂MeCH—NH(CH₂)₃NH(CH₂)₃NH—CHMeCH₂CHMe₂
Me₂CHCH₂MeCH—NH(CH₂)₄NH(CH₂)₄NH—CHMeCH₂CHMe₂
Et₂CH—NH(CH₂)₃NH(CH₂)₃NH—CHEt₂
Et₂CH—NH(CH₂)₂NMe(CH₂)₂NH—CHEt₂
Et₂CH—NH(CH₂)₃NMe(CH₂)₃NH—CHEt₂
Et₂CH—NH(CH₂)₄NMe(CH₂)₄NH—CHEt₂
EtMeCH—NH(CH₂)₃NMe(CH₂)₃NH—CHEtMe
(Me₂CH)₂CH—NH(CH₂)₃NMe(CH₂)₃NH—CH(CHMe₂)₂
Me₂CHCH₂MeCH—NH(CH₂)₂NMe(CH₂)₂NH—CHMeCH₂CHMe₂
Me₂CHCH₂MeCH—NH(CH₂)₃NMe(CH₂)₃NH—CHMeCH₂CHMe₂
Me₃C—NH(CH₂)₂N(CMe₃) (CH₂)₂NH—CMe₃
Me₃C—NH(CH₂)₃NCMe(CH₂)₃NH—CMe₃
Et₂CH—NH(CH₂)₃NEt(CH₂)₃NH—CHEt₂
Et₂CH—NH(CH₂)₃N(CHMe₂) (CH₂)₃NH—CHEt₂
Et₂CH—NH(CH₂)₂NH(CH₂)₂NH—CHEt₂
Et₂CH—NH(CH₂)₄NH(CH₂)₄NH—CHEt₂
Et₂CH—NH(CH₂)₃NH(CH₂)₃NH—CHMeCH₂CHMe₂
EtMeCH—NH(CH₂)₃NH(CH₂)₃NH—CHMeCH₂CHMe₂
EtMeCH—NH(CH₂)₃NMe(CH₂)₃NH—CHMeCH₂CHMe₂
Et₂CH—NH(CH₂)₂NH(CH₂)₂NH—CHMeCH₂CHMe₂
EtMeCH—NH(CH₂)₂NH(CH₂)₂NH—CHMeCH₂CHMe₂

Among these, the following compounds are preferred.
Et₂CH—NH(CH₂)₂NH—CHEt₂
Et₂CH—NH(CH₂)₃NH—CHEt₂
Et₂CH—NH(CH₂)₄NH—CHEt₂
Me₂CHCH₂MeCH—NH(CH₂)₂NH(CH₂)₂NH—CHMeCH₂CHMe₂
Me₂CHCH₂MeCH—NH(CH₂)₃NH(CH₂)₃NH—CHMeCH₂CHMe₂
Me₂CHCH₂MeCH—NH(CH₂)₄NH(CH₂)₄NH—CHMeCH₂CHMe₂
Et₂CH—NH(CH₂)₂NMe(CH₂)₂NH—CHEt₂
Et₂CH—NH(CH₂)₃NMe(CH₂)₃NH—CHEt₂
Et₂CH—NH(CH₂)₄NMe(CH₂)₄NH—CHEt₂
Me₂CHCH₂MeCH—NH(CH₂)₂NMe(CH₂)₂NH—CHMeCH₂CHMe₂
Me₂CHCH₂MeCH—NH(CH₂)₃NMe(CH₂)₃NH—CHMeCH₂CHMe₂

Two or more of these amine compounds can be used in combination.

The structure of the amine compound is measured by ¹H-NMR and/or ¹³C-NMR analysis.

A method for synthesizing the liquid compound having a secondary amine structure used in the first embodiment will be briefly described. The following synthesis methods are examples, and the synthesis methods of the compounds are not limited thereto.

A first synthesis method is a nucleophilic substitution reaction between an amine and a haloalkane. For the compound of formula (a), X—R²—X (X is, for example, Br) is reacted with R¹NH₂(R³NH₂), and, for the compound of Formula (b), X—R⁵—NR⁶—R⁷—X is reacted with R⁴NH₂(R⁸NH₂), whereby desired compounds can be obtained.

A second synthesis method is a reductive amination reaction of a ketone. For the compound of formula (a), a desired amine compound can be obtained by reducing an imine derivative obtained by reacting NH₂—R²—NH₂ with R′R″C═O. At this time, R¹ or R³ is CHR′R″. For the compound of formula (b), NH₂—R⁵—NR⁶—R⁷—NH₂ may be used instead of NH₂—R²—NH₂. At this time, R⁴ or R⁸ is CHR′R″.

In the acid gas absorbent according to the embodiment, a ratio of water to the liquid amine compound is preferably 0.3 to 10, on a mass basis, when the liquid amine compound is 1.

In general, an acid gas absorbent having a high content rate of the amine compound has large amounts of the acid gas to be absorbed and to be desorbed per unit volume, and has a high absorption rate and desorption rate of the acid gas, and thus is preferable in terms of energy consumption, size of plant facility, and treatment efficiency.

The acid gas absorbent having a content rate of the amine compound in the above range, when used for recovering the acid gas, is advantageous in that it can effectively recover the acid gas because it has an appropriate viscosity and high amounts and rates of the acid gas to be absorbed and to be desorbed.

The acid gas absorbent according to the embodiment may contain a surfactant and/or an antifoaming agent. Content rates of them are each preferably 0.1 to 1000 ppm, and more preferably 0.1 to 100 ppm, based on a total mass of the amine compound. The content rates are each even more preferably 2 to 20 ppm. A higher content rate of the surfactant than that of the antifoaming agent provides a larger effect for improving dissipation of the amine compound. Preferable specific examples of the antifoaming agent can include a silicone-based antifoaming agent and an organic antifoaming agent. The antifoaming agent can prevent foaming of the acid gas absorbent, suppress, for example, a decrease in absorption efficiency and desorption efficiency of the acid gas, and prevent a decrease in fluidity or circulation efficiency of the acid gas absorbent.

A viscosity when the amine compound and water absorb the acid gas to form a uniform phase is not particularly limited, but is preferably 1 to 200 mPa's and more preferably 10 to 100 mPa·s at 25° C. The viscosity is even more preferably 40 to 60 mPa·s.

Here, the viscosity of the acid gas absorbent can be measured by VISCOMETER DV-II+Pro (trade mark) manufactured by BROOKFIELD.

The acidic gas absorbent according to the first embodiment may contain a surfactant or an antifoaming agent as described above in addition to the liquid amine compound and water, and may contain other optional components as necessary.

In addition, examples of the optional components include an antioxidant, a pH adjusting agent, and an anticorrosive.

Preferable specific examples of the antioxidant can include dibutylhydroxytoluene (BHT), butylhydroxyanisole (BHA), sodium erythorbate, sodium nitrite, sulfur dioxide, 2-mercaptoimidazole, and 2-mercaptobenzimidazole. When the antioxidant is used, the content rate thereof is preferably 0.01 to 1 mass %, and particularly preferably 0.1 to 0.5 mass % based on the total mass of the acid gas absorbent. The antioxidant can prevent deterioration in acid gas absorbent and improve life thereof.

Preferable specific examples of the anticorrosive can include phosphoric acid esters, tolyltriazoles, and benzotriazoles. When the anticorrosive is used, the content rate thereof is preferably 0.00003 to 0.0008 mass %, and particularly preferably 0.00005 to 0.005 mass % based on the total mass of the acid gas absorbent. Such an anticorrosive can prevent corrosion of plant equipment and improve life thereof.

The acidic gas absorbent according to the first embodiment preferably does not contain an organic compound having a boiling point of 100° C. or lower. When the organic compound having a boiling point of 100° C. or lower is not contained, the organic compound is less likely to volatilize in the acid gas absorption process, and as a result, the loss of the absorbent can be reduced, and further, the damage to the apparatus is reduced. Further, the possibility of inducing the cause of environmental pollution is reduced. Therefore, even in a case where an organic compound such as an organic solvent is used for the purpose of improving solubility, the content rate thereof is preferably 1 mass % or less based on the total mass of the acidic gas absorbent.

In addition, the acid gas absorbent according to the first embodiment preferably does not contain a metal. This is because the metal may cause damage such as corrosion to an apparatus with which the acid gas absorbent is brought into contact. Therefore, the acid gas absorbent preferably has a metal content rate of zero. However, the acid gas absorbent may be brought into contact with a device during use, so that a metal may be eluted from the device. Therefore, inclusion of a very small amount of a metal is acceptable. However, even in such a case, a content rate of the metal is preferably 1 mass? or less based on the total mass of the acid gas absorbent.

As described above, according to the acidic gas absorbent of the first embodiment, it is possible to absorb and recover acidic gas such as carbon dioxide from gas to be treated with excellent efficiency. Further, handling and regeneration of the acidic gas absorbent are facilitated.

The acidic gas absorbent according to the first embodiment containing the specific liquid amine compound and water has a further improved amount of acidic gas (particularly, carbon dioxide) absorbed per unit mole, a further improved amount of acidic gas absorbed per unit volume of the acidic gas absorbent, and a further improved acidic gas absorption rate.

The water treatment apparatus 21 includes a treatment vessel 22. The treatment vessel 22 includes a first chamber 23 capable of accommodating the water to be treated, a second chamber 24 capable of accommodating an acidic gas absorbent that has absorbed acidic gas (first solution) as a draw solution, and a semipermeable membrane 25 that separates the first chamber and the second chamber.

The first chamber 23 of the treatment vessel 22 can contain the water to be treated. The second chamber 24 of the treatment vessel 22 can accommodate a working medium. The working medium is also referred to as a draw solution.

The acidic gas absorbent having absorbed the acidic gas (first solution) is sent from the absorber 12 to the second chamber 24 of the water treatment apparatus 21 provided on the downstream side of the absorber 12.

The water to be treated is a liquid having a lower solute concentration than the draw solution. In the present embodiment, the water to be treated is washing water containing amine, which is stored in the water to be treated tank 41. The water to be treated is supplied from the water to be treated tank 41 to the first chamber 23 through the flow path L6. The water to be treated is not limited to the washing water containing amine stored in the water to be treated tank 41. The water to be treated may be, for example, salt water (seawater or the like), lake water, river water, marsh water, domestic wastewater, industrial wastewater, or a mixture thereof, which is stored in a tank (not shown).

The first chamber 23 can be provided through a flow path L6 on the downstream side of a tank 41 for storing the water to be treated. A flow path L7 for discharging the concentrated water generated in the first chamber 23 is connected to the first chamber 23. The concentrated water remaining after the liquid in the first chamber 23 is permeated into the chamber 24 through the semipermeable membrane 25 is sent to the storage tank 42 through the flow path L7. Since a part of the concentrated water can be reused as the acidic gas absorbent, the concentrated water may be returned to the acidic gas removal system 1. Although FIG. 1 shows an example in which a part of the concentrated water is returned to the regenerator 32 through the flow path L14, the present invention is not limited to this. In addition, another part of the concentrated water may be discharged to the outside of the acidic gas removal system 1. The generated concentrated water contains an amine compound. In the present specification, the amine compound may be simply referred to as an amine.

The second chamber 24 is connected to a flow path L8 for delivering the acidic gas absorbent which has absorbed the acidic gas (first liquid) from the absorber 12 as a working medium (draw solution). A flow path L9 for discharging the working medium is connected to the second chamber 24.

The semipermeable membrane 25 is a forward osmosis membrane or a reverse osmosis membrane. The semipermeable membrane 25 may be, for example, a flat membrane, a hollow fiber, or a tubular type. The shape of the semipermeable membrane 25 is not particularly limited, and examples thereof include a spiral type, a plate and frame type, a straight type, and a cross wind type. The cross section of the forward osmosis membrane used as the semipermeable membrane 25 has a unification structure of a support layer and an active layer, and allows water to selectively permeate therethrough. Its material is not particularly limited, but is preferably formed of, for example, cellulose acetate, polyamide, polyethyleneimine, polysulfone, polybenzimidazole, or the like.

The reverse osmosis membrane used as the semipermeable membrane 25 has a support layer and an active layer, and selectively permeates water. Its material is not particularly limited, but it is preferable that the material is formed of, for example, polyamide, polyvinyl alcohol, polysulfone polyolefin, polyvinylidene fluoride, or the like.

The amine-containing water is supplied to the first chamber 23 partitioned by the semipermeable membrane 25 through the flow path L6. Before or after the water to be treated is supplied to the first chamber 23, the working medium is supplied to the second chamber 24 through the flow path L8. At this time, the working medium supplied to the second chamber 24 has a higher ion molar concentration than the amine concentration of the water to be treated supplied to the first chamber 23. Therefore, an osmotic pressure difference is generated between the water to be treated in the first chamber 23 and the working medium in the second chamber 24, and water in the water to be treated permeates the semipermeable membrane 25 and moves to the working medium side of the second chamber 24. The water to be treated in the first chamber 23 is concentrated by the movement of the permeated water obtained by the water in the water to be treated permeating the semipermeable membrane 25. Although not shown, the flow path L6 and the flow path L7 are connected to each other, and the liquid is circulated in the first chamber 23, whereby the liquid can be more highly concentrated. On the other hand, the working medium in the second chamber 24 is diluted with water that has permeated through the second chamber 24, and is discharged to the outside of the water treatment apparatus 21 through the flow path L9. Although not shown, it is also possible to perform an operation in which the flow path L8 and the flow path L9 are connected to each other and the working medium is circulated in the second chamber 24.

The pH of the amine-containing water to be treated is preferably adjusted to a range of 6 to 9. In addition, from the viewpoint of durability of the semipermeable membrane 25, the pH of the water to be treated is more preferably adjusted to 7 to 8.

In the first embodiment, an example in which the acidic gas absorbent that has absorbed the acidic gas (first solution) in the absorption apparatus 11 is applied as the working medium of the water treatment apparatus 21 has been described. However, as the working medium, any medium can be applied as long as it can induce positive osmotic pressure in the second chamber 24. A medium containing at least one compound selected from amine compounds which absorb an acidic gas and form a homogeneous phase with water can be used. These amine compounds may be small molecules or macromolecules. The working medium may be a mixed solution of various salts such as seawater. The working medium may be in the form of an aqueous solution, a nano-sized granular material, or a gel-like material.

In the acidic gas removal system 1 according to the first embodiment, in a case where an osmotic pressure generator including a forward osmosis membrane as the semipermeable membrane 25 is used, it is possible to operate at a lower pressure. Even under such conditions, the amine-containing water to be treated can be highly concentrated by the properties of the semipermeable membrane 25 and the osmotic pressure induced in the working medium. The forward osmosis membrane process operating at low pressure can use a forward osmosis membrane having a thinner support layer and a looser active layer structure compared to reverse osmosis membranes. Although the forward osmosis phenomenon occurs even in the reverse osmosis membrane, the forward osmosis membrane can recover amine more efficiently than the reverse osmosis membrane when the operation is performed at the same flux.

As described above, according to the first embodiment, the acidic gas absorbent which has absorbed the acidic gas (first solution) in the absorption apparatus 11 is applied as the working medium of the water treatment apparatus 21, and thus it is not necessary to additionally prepare the working medium of the water treatment apparatus, and thus it is possible to provide a compact acidic gas treatment system as a whole.

In addition, the treated gas accompanied by a part of the absorbent liquid is sent from the top of the absorber 12 to the diffusion suppressing unit 13, where the absorption liquid component (amine) is washed with water, and the washing water is concentrated and circulated as the treated water in the water treatment apparatus 21 without being discharged to the outside of the system, whereby the treated gas can be reused as the absorption liquid for the exhaust gas treatment in the absorber 12. As a result, it is possible to provide an acid gas removal system which can reduce the amount of waste such as waste water of washing water containing amine, can omit or downsize waste water treatment equipment as a system, and has a low environmental load and high economic efficiency because the absorption liquid is reused.

### First Modification of First Embodiment

The acidic gas removal system 1 may further include a regeneration apparatus 31. The regeneration apparatus includes a regenerator 32.

In this modification, as a result of applying the acidic gas absorbent (first solution) that has absorbed acidic gas in the absorption apparatus 11 as the working medium of the water treatment apparatus 21 in the first embodiment, the diluted working medium (an acidic gas absorbent that has absorbed acidic gas containing water (second solution))) is regenerated.

The acidic gas absorbent that has absorbed the acidic gas containing water (second liquid) is discharged from the second chamber 24 to the outside of the water treatment apparatus 21 through the flow path L9, and is sent to the regenerator 32 of the regeneration apparatus 31 by a liquid sending unit such as a pump after passing through the heat-exchanger 26 provided on the downstream side of the second chamber 24. The second solution fed into the regenerator 32 moves from the upper portion to the lower portion of the regenerator 32, during which the acidic gas in the acidic gas absorbent is desorbed and the acidic gas absorbent is regenerated. In the process of the acid gas desorption, the amine compound is generated from the amine compound and the salt of the acid gas in the acid gas absorption liquid, and is separated into an amine compound phase AP and an aqueous phase WP at the bottom of the regenerator 32.

Examples of a method for separating the acid gas such as carbon dioxide from the acid gas absorbent that has absorbed the acid gas and recovering pure or high-concentration acid gas include a method of heating the acid gas absorbent while expanding a liquid interface in a shelf tower, a spray tower, or a regeneration tower containing a filler made of porcelain or metal mesh.

The acidic gas absorbent regenerated in the regenerator 32 (lean liquid) is fed to the heat-exchanger 26 and an absorbent cooler (not shown) provided on the downstream side of the regenerator 32 by a liquid feeding means such as a lean liquid pump, and is returned to the absorber 12 from the acidic gas absorbent supplying port L2. In FIG. 1, the number of the liquid sending path for the lean liquid is one, but the amine compound phase and the aqueous phase separated into two phases in the regenerator 32 can be sent independently. Each of the two types can be independently purified. When the amine compound phase and the aqueous phase are independently sent from the regenerator 32, the respective phases are purified as necessary, and then mixed at any stage before being supplied to the absorber 12. In mixing, the mixing ratio of the amine compound and water may be adjusted to improve the efficiency of acid gas absorption. In adjusting the mixing ratio, an amine compound or water may be newly added. In addition, when the regenerated acidic gas absorption liquid is reused, it is preferable to disperse the acidic gas absorption liquid separated into two phases by stirring or the like before the acidic gas absorption liquid is brought into contact with the exhaust gas in the absorber 12.

The top of the regenerator 32 is connected to the gas purification unit 33 by a flow path L10. The reflux water in which the acidic gas is dissolved is discharged from the top of the regenerator 32, cooled, and then separated into a liquid component and a purified acidic gas in the gas purification unit 33 provided on the downstream side of the regenerator 32. The purified acidic gas is recovered in the acidic gas recovery unit 34 through the flow path L11. On the other hand, a part of the liquid components is returned to the regenerator 32 by the flow path L12. Further, another part of the liquid components may be recovered in the water-to-be-treated tank 41 provided on the downstream side of the regenerator 32 by the flow path L13. Thus, the other part of the liquid component is concentrated in the water treatment apparatus 21, and the acidic gas absorbent can be reused.

In the third step (regeneration step), the amount of the acid gas to be desorbed increases as the temperature increases. For this reason, the acid gas absorbent is generally heated to about 120° C. in many cases. However, when the temperature is increased, the energy required for heating the absorbent is increased, and thus a low temperature at the time of regeneration is preferable. Since the liquid amine compound used in the acid gas absorbent according to the embodiment sufficiently releases the acid gas at a low temperature, the acid gas absorbent can be regenerated at a temperature lower than that for a general acid gas absorbent. Specifically, the acid gas absorbent can be regenerated generally at 100° C. or lower, preferably 80° C. or lower, and more preferably 70° C. or lower. In addition, a pressure during regeneration can be usually about 1 to 3 atm, but the acid gas can be efficiently released by reducing the pressure. In the third step, either heating or pressure reduction can be employed, and they can also be combined in order to improve the efficiency of the regeneration.

The acid gas absorbent after release of the acid gas can be sent to the first step (absorption step) again for circulation use (recycling). Since the acid gas absorbent from which the acid gas has been separated is separated into two phases, i.e., an amine compound phase and an aqueous phase, these phases are adjusted to achieve a predetermined composition as necessary and sent to the first step (absorption step). According to need, stirring or mixing can be performed before the first step (absorption step). Since a contact efficiency of the amine compound with the aqueous phase and the acid gas affects the acid gas absorption rate, it is necessary to efficiently contact them. In addition, in the first step (absorption step), heat generated at the time of absorption of the acid gas is generally used for a course of recycling the acid gas absorbent, that is, for heating an acid gas absorption liquid injected into a regenerator in the third step.

The purity of the thus recovered acid gas is usually as high as about 95 to 99 vol %. The pure acid gas or the high-concentration acid gas can be used as a synthetic raw material for a chemical product or a polymer substance, a cooling agent for freezing foods, or the like. In addition, it is also possible to isolate and store the recovered acid gas in the underground or the like that is now under technical development.

According to this modification, by using the acidic gas absorbent of the embodiment, the acidic gas absorbent can be separated into an amine compound phase and an aqueous phase in the third step (regeneration step). In a general acidic gas removal method, the acidic gas absorbent constituting one phase after the acidic gas is desorbed is subjected to a purification treatment. In contrast, in the acidic gas removal method according to the embodiment, the heterogeneous acidic gas absorbent constituting two phases can be collectively subjected to the purification treatment, but the amine compound phase and the aqueous phase can be independently generated.

In the present modification, the acidic gas absorbent that has absorbed acidic gas (first liquid) flows through the flow path L8, the water treatment apparatus 21, and the flow path L9, and is sent to the regenerator 32 as the acidic gas absorbent that has absorbed acidic gas containing water (second liquid). However, a part of the acidic gas absorbent which has absorbed the acidic gas (first solution) may flow to the flow path L8 and be sent to the regenerator 32 after passing through the heat-exchanger 26. A flow path through which the acidic gas absorbent flows without passing through the water treatment apparatus 21 is referred to as a second flow path. A part of the acidic gas absorbent which has absorbed the acidic gas (first solution) may be fed to the regenerator 32 as the second solution via the first flow path, and a part of the first solution may be fed to the regenerator 32 via the second flow path. In the present modification, an example in which the second solution is subjected to desorption of the acidic gas in the acidic gas absorbent in the regenerator 32, and the acidic gas absorbent is regenerated has been described. When the first solution is fed to the regenerator 32 via the first flow path, the acidic gas in the acidic gas absorbent is desorbed in the regenerator 32, and the acidic gas absorbent is regenerated.

In addition, in the present modification, for example, a second regenerator (not shown) may be further provided independently from the regenerator 32. A configuration may be adopted in which the acidic gas absorbent that has absorbed the acidic gas (first solution) and that does not pass through the water treatment apparatus 21 flows to the regenerator 32, and the acidic gas absorbent (first solution)) that has passed through the water treatment apparatus 21 flows to the second regenerator.

The second regenerator has a configuration including, for example, an acidic gas release unit for releasing an acidic gas from the working medium, and a phase separation unit for separating the phase-separated working medium. As the phase separation unit, a three phase separation type centrifugal separator or the like can be used. As the acidic gas releasing unit, a heating equipment, an inert gas bubbling equipment, or the like can be used.

The acid gas absorbent regenerated in the second regenerator is fed to the heat exchanger 26 and an absorbing agent cooler (not shown) by a liquid feeding unit such as a lean liquid pump, and is returned to the absorber 12 from the acidic gas absorbent supplying port L2.

As described above, according to the modification of the first embodiment, the reflux water in which the acidic gas is dissolved is sent from the top of the regenerator 32 to the gas purification unit 33, the reflux water is separated into the liquid component and the purified acidic gas, and the liquid component is concentrated and circulated as the water to be treated in the water treatment apparatus 21 without being discharged to the outside of the system, thereby being reused as the absorption liquid of the exhaust gas treatment of the absorber 12. As a result, in addition to the first embodiment, it is possible to provide an acidic gas removal system which can further reduce the amount of waste such as waste water of washing water containing amine, can omit or downsize waste water treatment equipment as the entire system, and has a low environmental load and high economic efficiency because the absorption liquid is reused.

### Second Modification of First Embodiment

The acidic gas removal system 1 according to the first embodiment may be configured to include a plurality of treatment vessel 22 as the water treatment apparatus 21. The plurality of treatment vessel 22 may be arranged in series, in parallel, or in a combination thereof.

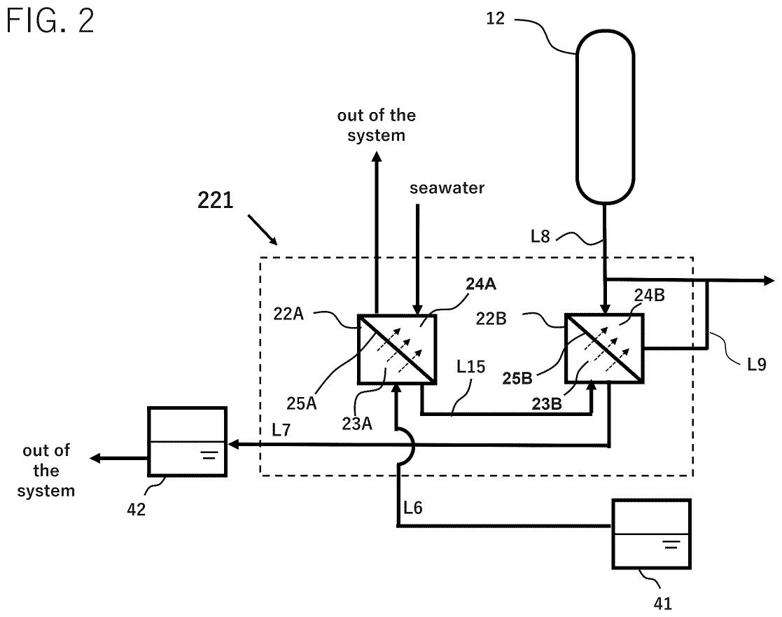

FIG. 2 is a diagram showing a water treatment apparatus 221 of modification 2 of the first embodiment. In the water treatment apparatus 221, the treatment vessels 22A and 22B are arranged in series.

The treatment vessel 22A is in front of the treatment vessel 22B. The treatment vessel 22A includes a first chamber 23A capable of containing the water to be treated, a second chamber 24A capable of containing the draw solution, and a semipermeable film 25A. As the water to be treated stored in the first chamber 23A, the amine-containing water stored in the water to be treated tank 41 is introduced. The draw solution contained in the second chamber 24A is, for example, seawater. Although not shown, for example, seawater stored in a tank may be introduced into the second chamber 24A. The draw solution contained by the second chamber 24A has a higher molarity of ions than the water-to-be-treated contained by the first chamber 23A. Similar draw performances can be obtained with NaCl at 3.5 Wt % when seawater is used as the draw solution. The draw solution accommodated in the second chamber 24A is not limited to seawater, and aqueous solutions of various substances such as NaCl, MgCl2, and sucrose can be used. In the 22A of the treatment vessel, an osmotic difference is generated between the amine-containing water to be treated in the 23A of the first chamber and the draw solution in the 24A of the second chamber, and the water to be treated permeates through the semi-permeable membrane 25A and moves to the draw solution side of the second chamber 24A.

The amine-containing water on the first chamber 23A is concentrated by the movement of the permeate which is the amine-containing water to be treated permeated through the semi-permeable membrane 25A.

The concentrated a min-containing water to be treated in the first chamber 23A is introduced into the first chamber 23B of the treatment vessel 22B in the subsequent stage through the flow path L15. The draw solution (seawater) in the second chamber 24A is diluted with water that has permeated. The diluted draw solution (seawater) is discharged to the outside of the system.

The treatment vessel 22B has the same configuration as the treatment vessel 22 described in FIG. 1. The treatment vessel 22B includes a first chamber 23B capable of accommodating the water to be treated, a second chamber 24B capable of accommodating the acidic gas absorbent that has absorbed the acidic gas (first liquid) as the draw solution, and a semipermeable film 25B. The absorber 12 sends the acid gas absorbent (first liquid) to the second chamber 24B through the flow path L8. Unlike the treatment vessel described with reference to FIG. 1, the water to be treated contained in the first chamber 23B is the water to be treated containing the concentrated amine discharged from the first vessel 22A of the treatment vessel 23A in the preceding stage. In the treatment vessel 22B, an osmotic differential is generated between the concentrated amine-containing water in the first chamber 23B and the draw solution in the second chamber 24B, and the water to be treated permeates through the semipermeable film 25B and moves to the draw solution side of the second chamber 24B. As a result, the concentrated amine-containing water to be treated in the first chamber 23B is further concentrated. The treated water containing the further concentrated amine is sent to the storage tank 42 through the flow path L7. The diluted draw solution is sent to the regenerator 32 described later through the flow path L9.

According to the water treatment apparatus 221, since the treatment vessel 22A and the treatment vessel 22B are arranged in series, the amine-containing water to be treated can be concentrated in two stages, and the concentration rate can be increased. The water to be treated treated in the treatment vessel 22B in the subsequent stage is concentrated in the treatment vessel 22A in the preceding stage. Therefore, less water permeates into the draw solution in the second chamber 24B. The diluted draw solution is regenerated in the regenerator 32 for reuse as the acidic gas absorbent, but the energy used in the regeneration treatment can be reduced because the amount of water contained in the diluted draw solution is small.

In the acidic gas removal system 1, a large amount of amine containing water to be treated is generated, and the amine concentration is low in many cases. As in this modification, the concentration rate can be increased by concentrating the water to be treated, which has been concentrated once by using seawater as the draw solution on the treatment vessel 22A, on the treatment vessel 22B. In addition, the energy used for the regeneration treatment of the acidic gas absorbent in the draw solution diluted in the treatment vessel 22B can be significantly reduced.

According to this modification, it is possible to improve the concentration rate of the water to be treated (amine-containing washing water) and to reduce the energy used in the regeneration treatment of the acidic gas absorbent in the draw solution.

In the present modification, the treatment vessel is configured to have two stages, but may be configured to have three or more stages. By configuring the treatment vessel to have three or more stages, it is possible to further improve the concentration rate and to reduce the energy of the regeneration treatment.

### EXAMPLE

Examples of the present embodiment will be described below. In the following examples, the conditions before heating the acidic gas absorbent are set to 25° C. and atmospheric pressure. In this example, the amount of concentrated amine containing water discharged when raw amine containing water as water to be treated is treated using the water treatment apparatus 21, the absorber 12, and the regenerator 12 according to the first embodiment is simulated as the amount of treatment per unit time.

One part by volume (about 4.5 g/L) of amine raw water to be treated is introduced into the first chamber 23 of the water treatment apparatus 21. The flow rate of the acidic gas absorbent output from the absorber 21 is 0.5 parts by volume.

The amine raw water is concentrated by the water treatment apparatus 21, and 0.011 parts by volume (about 400 g/L) of amine-concentrated water is obtained from the first chamber 23. The amine raw water as the water to be treated is concentrated by about 90 times. The water of the water phase WP output by the regenerator 32 is then subjected to NF membrane treatment to obtain 1 part by volume of clean water.

As shown in the present embodiment, the volume of the wastewater can be greatly reduced by discharging the amine-concentrated water concentrated in the water treatment apparatus 21, as compared with the case where the amine raw water is discharged to the outside of the system as it is.

The embodiment may include the following configurations.

### [Configuration 1]

An acidic gas removal method for removing an acidic gas from a gas to be treated containing the acidic gas, the method including:
bringing the gas to be treated into contact with an acidic gas absorbent to cause the acidic gas absorbent to absorb the acidic gas as a first step; and
obtaining a draw solution diluted with water by using the acidic gas absorbent having absorbed the acidic gas in the first step as a draw solution and allowing water contained in the water to be treated to permeate through a semipermeable membrane to the draw solution side as a second step.

### [Configuration 2]

The method for removing an acidic gas according to [Configuration 1], further including
releasing a part of the acidic gas from the draw solution diluted with water to regenerate the acidic gas absorbent as a third step.

### [Configuration 3]

The method for removing an acidic gas according to [Configuration 1] or [Configuration 2], in which
the acidic gas absorbent is a mixture containing a polarity inversion compound and water.

### [Configuration 4]

The acidic gas removal method according to [Configuration 3], in which
the polarity inversion compound is a liquid amine compound having a secondary amine structure, and a dissolution amount of a salt formed from the liquid amine compound and the acidic gas in water is higher than a dissolution amount of the liquid amine compound in water.

### [Configuration 5]

The acidic gas absorption method according to any one of [Configurations 2] to [Configuration 4], in which
the acidic gas absorbent is in a state of being phase-separated into an organic phase and an aqueous phase after releasing a portion of the acidic gas in the third step.

### [Configuration 6]

The method for removing an acidic gas according to any one of [Configuration 4] and [Configuration 5], in which
the liquid amine compound has a water-soluble amount of 50 000 mg/L or less at 25° C.

### [Configuration 7]

The method for removing an acidic gas according to any one of [Configurations 4] to [Configuration 6], in which
the liquid amine compound is represented by the following formula (a) or (b):

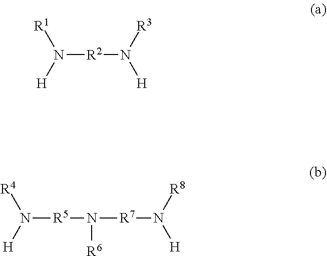

in which
R¹, R³, R⁴, and R⁸ are each independently a linear alkyl group, a branched alkyl group, a cyclic alkyl group, a heterocyclic aliphatic group containing oxygen or sulfur, a substituted or unsubstituted aliphatic group composed of three elements of carbon, nitrogen and hydrogen atoms, or a substituted or unsubstituted aromatic group,
R², R⁵, and R⁷ are each independently a C1 to C7 linear alkylene chains or C3 to C7 branched alkylene chains, and
R⁶ is linear alkyl groups, branched alkyl groups, substituted or unsubstituted aliphatic groups composed of three elements of carbon, nitrogen and hydrogen atoms, a substituted or unsubstituted aromatic group, or hydrogen.

### [Configuration 8]

The method for removing an acidic gas according to [Configuration 7], in which
R¹, R³, R⁴, and R⁸ are each independently a linear or branched C3 to C6 alkyl group,
R², R⁵, and R⁷ are each independently a C2 to C4 linear alkylene chain or a C3 to C4 branched alkylene chain, and
R⁶ is a linear or branched C1 to C3 alkyl group, or hydrogen.

### [Configuration 9]

The acidic gas removing method according to [Configuration 7] or [Configuration 8], in which
R¹ and R³ are identical, and
R⁴ and R⁸ are identical.

### [Configuration 10]

The acidic gas removal method according to any one of [Configurations 2] to [Configuration 9], in which
the released acidic gas is recovered in the third step.

### [Configuration 11]

The acidic gas removing method according to any one of [Configurations 2] to [Configuration 10], in which the acidic gas absorbent regenerated in the third step is reused in the first step.

### [Configuration 12]

The method for removing an acidic gas according to any one of [Configurations 1] to [Configurations 11], further including
stirring and mixing an acidic gas absorbent in advance before the first step.

### [Configuration 13]

The method for removing an acidic gas according to any one of [Configurations 4] to [Configurations 12], in which
the gas to be treated from which the acidic gas has been removed in the first step is at least partially removed by the liquid amine compound and then released into the environment.

### [Configuration 14]

The method for removing an acidic gas according to any one of [Configurations 2 to [Configurations 13], in which
the third step regenerates the acidic gas absorbent by heating and/or depressurization.

### [Configuration 15]

The acidic gas removal method according to any one of [Configurations 2] to [Configuration 14], in which
in the third step, the acidic gas absorbent is regenerated by heating the acidic gas absorbent using heat generated in the first step.

### [Configuration 16]

The acidic gas removing method according to any one of [Configurations 1] to [Configurations 15], wherein
the acidic gas is carbon dioxide.

### [Configuration 17]

A acidic gas removal system including;
an absorption apparatus including an absorber capable of accommodating an acidic gas absorption liquid capable of absorbing acidic gas; and
a water treatment apparatus including a treatment vessel including a first chamber capable of containing water to be treated, a second chamber provided on a downstream side of the absorber and capable of containing a draw solution, and a semipermeable membrane that separates the first chamber and the second chamber from each other.

### [Configuration 18]

The acidic gas removal system according to [Configuration 17],
the absorption apparatus includes a diffusion suppressing portion on a downstream side of the absorber, and
the first chamber is provided on a downstream side of the diffusion suppression unit.

### [Configuration 19]

The acidic gas removal system according to [Configuration 17] or [Configuration 18], further including
a regeneration apparatus including a regenerator on a downstream side of the second chamber.

### [Configuration 20]

The acidic gas removal system according to [19], further including
a gas purification unit is provided on a downstream side of the regenerator, and
the first chamber on a downstream side of the gas purification unit.

### [Configuration 21]

The acidic gas removal system according to [Configuration 19] or [Configuration 20], in which
the absorber is provided on a downstream side of the regenerator.

### [Configuration 22]

The acidic gas removal system according to any one of [Configuration 19] to [Configuration 21], further including
the regenerator provided on a downstream side of the first chamber.

### [Configuration 23]

The acidic gas removal system according to any one of [Configurations 17] to [Configuration 22], in which
the draw solution contains at least one selected from the group consisting of an inorganic salt, an amine compound, a saccharide, a polarity inversion compound, and a compound having a lower critical point solution temperature.

### [Configuration 24]

The acidic gas removal system according to any one of [Configuration 17] to [Configuration 23], in which
the acidic gas absorption liquid contains a polarity inversion compound whose compatibility with water changes by reacting with the acidic gas.

### [Configuration 25]

The acidic gas removal system according to [Configuration 24], in which
the polarity inversion compound includes a liquid amine compound having a secondary amine structure.

### [Configuration 26]

The acidic gas removal system according to [Configuration 25], in which
the liquid amine compound has a water-soluble amount of 50000 mg/L or less at 25° C.

### [Configuration 27]

The acid gas removal system according to any one of [Configurations 17] to [Configuration 26], in which
the draw solution is in a state of being phase-separated into an organic phase and an aqueous phase after releasing a portion of the acid gas in the regenerator.

According to the acidic gas removal method and the acidic gas removal system of at least one of the embodiments described above, it is possible to provide an acidic gas removal method and an acidic gas removal system which have a small amount of waste such as wastewater and are compact as a whole system.

While certain embodiments have been described, these embodiments have been presented by way of example only, and are not intended to limit the scope of the inventions. These novel embodiments can be implemented in various other forms, and various combinations, omissions, substitutions, changes, and the like can be made without departing from the spirit of the invention. These embodiments and modifications thereof are included in the scope and spirit of the invention, and are included in the invention described in the claims and the scope of equivalents thereof.

What is claimed is:

1. An acidic gas removal method for removing an acidic gas from a gas to be treated containing the acidic gas, the method comprising:
bringing the gas to be treated into contact with an acidic gas absorbent to cause the acidic gas absorbent to absorb the acidic gas as a first step; and
obtaining a draw solution diluted with water by using the acidic gas absorbent having absorbed the acidic gas as a draw solution and allowing water contained in the water to be treated to permeate through a semipermeable membrane to the draw solution side as a second step.

2. The method for removing an acid gas according to claim 1, further comprising
releasing a part of the acid gas from the draw solution diluted with water to regenerate the acidic gas absorbent as a third step.

3. The method for removing an acidic gas according to claim 1, wherein
the acidic gas absorbent is a mixture containing a polarity inversion compound and water.

4. The method for removing an acidic gas according to claim 3, wherein
the polarity inversion compound is a liquid amine compound having a secondary amine structure, and
a dissolution amount of a salt formed from the liquid amine compound and the acidic gas in water is higher than a dissolution amount of the liquid amine compound in water.

5. The acidic gas absorption method according to claim 2, wherein
the acidic gas absorbent is in a state of being phase-separated into an organic phase and an aqueous phase after releasing a portion of the acidic gas in the third step.

6. The method for removing an acidic gas according to claim 4, wherein
the liquid amine compound has a water-soluble amount of 50000 mg/L or less at 25° C.

7. The acidic gas absorption method according to claim 4, wherein
the liquid amine compound is represented by the following formula (a) or (b): 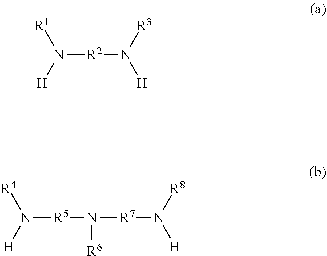
wherein
R¹, R³, R⁴, and R⁸ are each independently a linear alkyl group, a branched alkyl group, a cyclic alkyl group, a heterocyclic aliphatic group containing oxygen or sulfur, a substituted or unsubstituted aliphatic group composed of three elements of carbon, nitrogen and hydrogen atoms, or a substituted or unsubstituted aromatic group,
R², R⁵, and R⁷ are each independently a C1 to C7 linear alkylene chain or a C3 to C7 branched alkylene chain, and
R⁶ is a linear alkyl group, a branched alkyl group, a substituted or unsubstituted aliphatic group composed of three elements of carbon, nitrogen and hydrogen atoms, a substituted or unsubstituted aromatic group, or hydrogen.

8. The acidic gas absorption method according to claim 7, wherein
R¹, R³, R⁴, and R⁸ are each independently a linear or branched C3 to C6 alkyl group,
R², R⁵, and R⁷ are each independently a C2 to C4 linear alkylene chain or a C3 to C4 branched alkylene chain, and
R⁶ is a linear or branched C1 to C3 alkyl group, or hydrogen.

9. The acidic gas absorption method according to claim 8, wherein
R¹ and R³ are identical, and
R⁴ and R⁸ are identical.

10. The method for removing an acidic gas according to claim 2, wherein
the released acidic gas is recovered in the third step.

11. The method for removing an acidic gas according to claim 1, further comprising
stirring and mixing an acidic gas absorbent in advance before the first step.

12. A acidic gas removal system comprising;
an absorption apparatus including an absorber capable of accommodating an acidic gas absorption liquid capable of absorbing acidic gas; and
a water treatment apparatus including a treatment vessel including a first chamber capable of containing water to be treated, a second chamber provided on a downstream side of the absorber and capable of containing a draw solution, and a semipermeable membrane that separates the first chamber and the second chamber from each other.

13. The acidic gas removal system according to claim 12, wherein
the absorption apparatus includes a diffusion suppressing unit on a downstream side of the absorber, and
the first chamber is provided on a downstream side of the diffusion suppression unit.

14. The acid gas removal system according to claim 12, further comprising
a regeneration apparatus including a regenerator on a downstream side of the second chamber.

15. The acid gas removal system according to claim 14, further comprising
a gas purification unit is provided on a downstream side of the regenerator, and
the first chamber on a downstream side of the gas purification unit.

16. The acid gas removal system according to claim 14, wherein
the absorber is provided downstream side of the regenerator.

17. The acid gas removal system of claim 14, wherein
the regenerator is provided downstream of the first chamber.

18. The acidic gas removal system according to claim 12, wherein
the acidic gas absorption liquid contains a polarity inversion compound whose compatibility with water is changed by reacting with the acidic gas.

19. The acidic gas removal system according to claim 18, wherein
the polarity inversion compound comprises a liquid amine compound having a secondary amine structure.

20. The acidic gas removal system according to claim 19, wherein
the liquid amine compound has a water-soluble amount of 50000 mg/L or less at 25° C.
